(19) United States
(12) Patent Application Publication
(10) Pub. No.: US 2019/0095841 A1
(43) Pub. Date: Mar. 28, 2019

(54) SYSTEMS AND METHODS FOR RANKING PAGES BASED ON PAGE-TO-PAGE ENGAGEMENT GRAPHS ASSOCIATED WITH A SOCIAL NETWORKING SYSTEM

(71) Applicant: Facebook, Inc., Menlo Park, CA (US)

(72) Inventors: Yunzhi Ye, Seattle, WA (US); Komal Kapoor, Bellevue, WA (US); Bradley Ray Green, Snohomish, WA (US); Yixin Li, Kirkland, WA (US)

(21) Appl. No.: 15/717,907

(22) Filed: Sep. 27, 2017

(51) Int. Cl. G06Q 10/06; G06Q 50/00; G06F 7/02; G06N 99/00; G06T 11/20

(52) U.S. Cl. CPC G06Q 10/06393; G06Q 50/01; G06T 11/206; G06N 99/005; G06F 7/026

(57) ABSTRACT

Systems, methods, and non-transitory computer readable media can obtain a plurality of page engagement graphs, each of the plurality of page engagement graphs associated with a page engagement type of a plurality of page engagement types. Respective weights associated with the plurality of page engagement types can be determined. An aggregated page engagement graph can be generated based on the plurality of page engagement graphs and the respective weights. Pages in the aggregated page engagement graph can be ranked.

### FIELD OF THE INVENTION

The present technology relates to the field of social networks. More particularly, the present technology relates to techniques for ranking pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system.

### SUMMARY

Various embodiments of the present disclosure can include systems, methods, and non-transitory computer readable media configured to obtain a plurality of page engagement graphs, each of the plurality of page engagement graphs associated with a page engagement type of a plurality of page engagement types. Respective weights associated with the plurality of page engagement types can be determined. An aggregated page engagement graph can be generated based on the plurality of page engagement graphs and the respective weights. Pages in the aggregated page engagement graph can be ranked.

In some embodiments, each of the plurality of page engagement graphs includes edges between pages associated with a social networking system and respective values associated with the edges.

In certain embodiments, a value associated with an edge between two pages is indicative of a strength of a connection or relationship between the two pages.

In an embodiment, the generating the aggregated page engagement graph comprises: applying the respective weights to the values associated with the edges of the plurality of page engagement graphs to generate weighted values associated with the edges of the plurality of the page engagement graphs; aggregating the weighted values associated with the edges of the plurality of the page engagement graphs; and generating the aggregated page engagement graph that includes the edges of the plurality of the page engagement graphs and the aggregated weighted values.

In some embodiments, the ranking the pages in the aggregated page engagement graph comprises generating a score for each page in the aggregated page engagement graph, the score indicative of importance of the page.

In certain embodiments, the score for each page is determined based on edges from other pages to the page in the aggregated page engagement graph and respective scores of the other pages.

In an embodiment, the score for each page is determined recursively.

In some embodiments, a search query including search criteria can be received, a plurality of candidate pages can be identified based on the search criteria, and the plurality of candidate pages can be ranked based on respective scores of the plurality of candidate pages.

In certain embodiments, the determining the respective weights associated with the plurality of engagement types is based on a machine learning model.

In an embodiment, the plurality of engagement types includes one or more of: a page mentioning another page, a page becoming a fan of another page, or a page liking posts of another page.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example page engagement ranking module configured to rank pages based on page-to-page engagement, according to an embodiment of the present disclosure.

FIG. 2A illustrates an example engagement graph ranking module configured to rank pages based on page-to-page engagement graphs, according to an embodiment of the present disclosure.

FIG. 2B illustrates an example search module configured to provide pages in response to a search of data maintained by a social networking system, according to an embodiment of the present disclosure.

FIG. 3 illustrates a functional block diagram for ranking pages based on page-to-page engagement, according to an embodiment of the present disclosure.

FIG. 4 illustrates an example first method for ranking pages based on page-to-page engagement, according to an embodiment of the present disclosure.

FIG. 5 illustrates an example second method for ranking pages based on page-to-page engagement, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Ranking Pages Based on Page-to-Page Engagement Graphs Associated with a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

The social networking system may provide pages for various entities. For example, pages may be associated with companies, businesses, brands, products, artists, public figures, entertainment, individuals, and other types of entities. Pages can be dedicated locations on the social networking system to reflect a presence of entities on the social networking system. Conventional approaches specifically arising in the realm of computer technology can allow users to search for pages. For example, a user can enter a search query, and one or more pages relating to the search query can be returned by a social networking system. However, the social networking system can provide a significant number of pages, and there can be many similar pages. Accordingly, under conventional approaches, it can be difficult to provide relevant pages in response to a search query.

An improved approach rooted in computer technology can overcome the foregoing and other disadvantages associated with conventional approaches specifically arising in the realm of computer technology. Based on computer technology, the disclosed technology can rank pages based on page-to-page engagement. Page-to-page engagement can indicate engagement between pages of a social networking system, and can be represented by one or more page-to-page engagement graphs. For example, a page-to-page engagement graph can include edges between pages and values associated with the edges. There can be different types of engagement between pages, and a page-to-page engagement graph can be generated for each type of engagement. Types of engagement can include a page mentioning another page, a page fanning or becoming a fan of another page, a page liking posts of another page, etc. Page-to-page engagement graphs for different types of engagement can be aggregated in order to generate an aggregated page-to-page engagement graph that includes edges between pages and aggregated values associated with the edges. In some embodiments, respective weights can be determined for different types of engagement, and values for edges from different page-to-page engagement graphs can be aggregated based on the respective weights. A page ranking technique or algorithm can be applied to the aggregated page-to-page engagement graph, and a score can be generated for each page. If a search query for pages is received, the disclosed technology can identify candidate pages that are responsive to the search query and rank the candidate pages based on respective scores. The ranked candidate pages can be provided based on the order of ranking. In this manner, the disclosed technology can identify and provide pages that are relevant to a search query from a large number of pages available in the social networking system. Additional details relating to the disclosed technology are provided below.

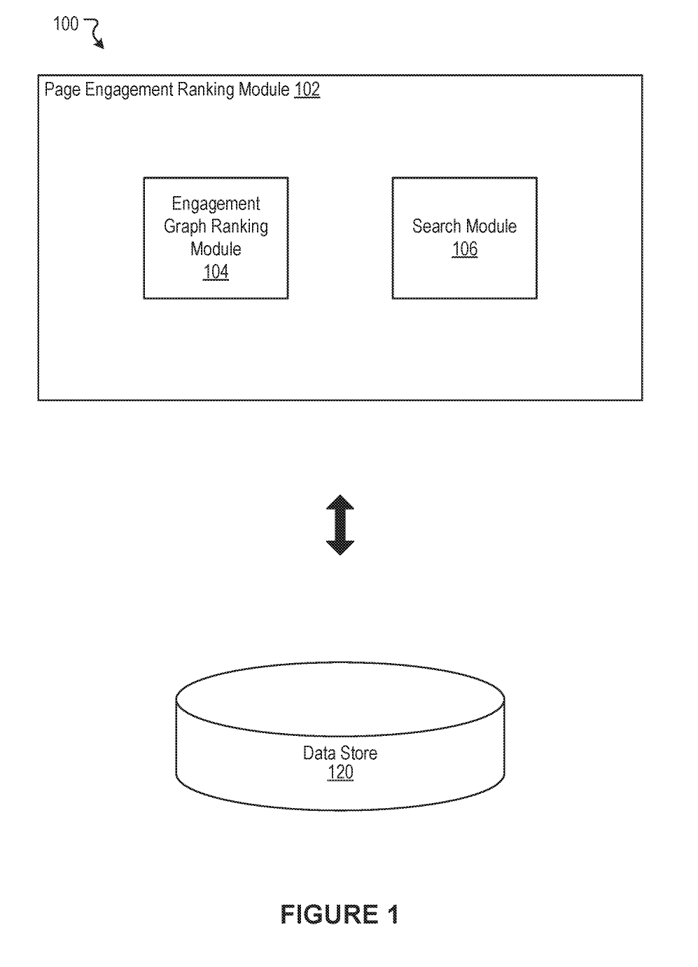

FIG. 1 illustrates an example system 100 including an example page engagement ranking module 102 configured to rank pages based on page-to-page engagement, according to an embodiment of the present disclosure. The page engagement ranking module 102 can include an engagement graph ranking module 104 and a search module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the page engagement ranking module 102 can be implemented in any suitable combinations. While the disclosed technology is described in connection with pages and page engagement data associated with a social networking system for illustrative purposes, the disclosed technology can apply to any other type of system and/or content. In some embodiments, the disclosed technology can also apply to engagement between other types of entities or objects distinct from pages. For example, the other types of entities or objects can be included in one or more graphs (e.g., social graph) reflecting interrelationships, interactions, and affinities among the entities or objects.

The engagement graph ranking module 104 can rank pages based on page-to-page engagement graphs. One or more page-to-page engagement graphs can be generated for different types of engagement between pages. An aggregated page engagement graph can be generated from the page-to-page engagement graphs for different types of engagement, and pages in the aggregated page engagement graph can be ranked. For example, a rank or score can be generated for each page in the aggregated page engagement graph. Functionality of the engagement graph ranking module 104 is described in more detail herein.

The search module 106 can provide pages in response to a search. For example, the search module 106 can identify one or more candidate pages that are candidates for inclusion in search results for a search query against data maintained by a social networking system by a user. The candidate pages can be ranked based on respective rankings or scores of the candidate pages. Functionality of the search module 106 is described in more detail herein.

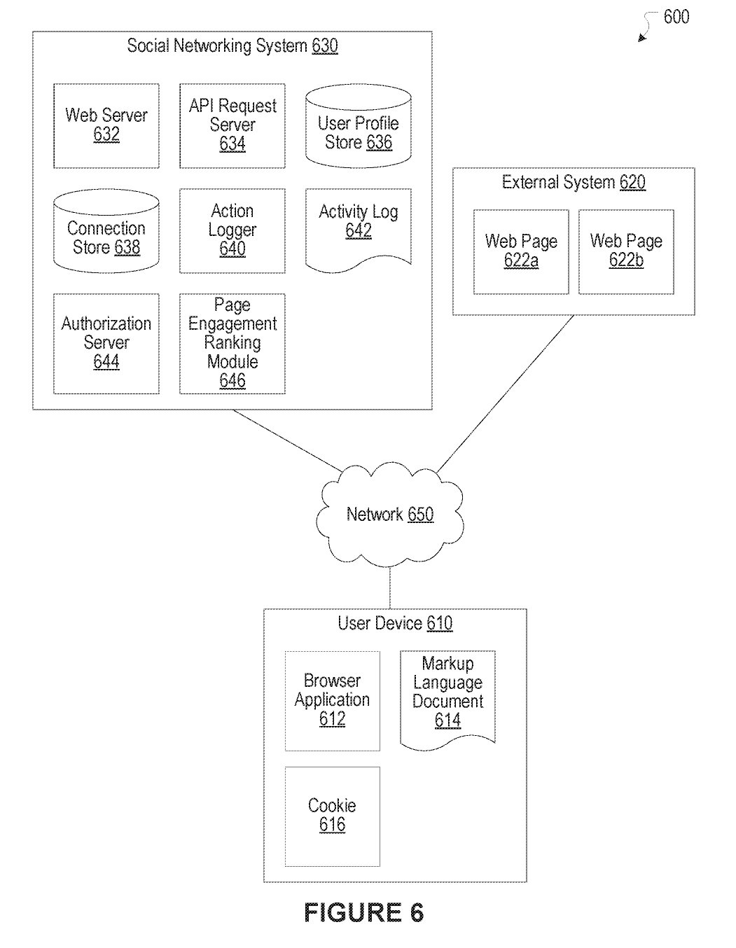

In some embodiments, the page engagement ranking module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page engagement ranking module 102 can be, in part or in whole, implemented as software running on one or more computing devices or systems, such as on a server system or a client computing device. In some instances, the page engagement ranking module 102 can be, in part or in whole, implemented within or configured to operate in conjunction or be integrated with a social networking system (or service), such as a social networking system 630 of FIG. 6. Likewise, in some instances, the page engagement ranking module 102 can be, in part or in whole, implemented within or configured to operate in conjunction or be integrated with a client computing device, such as the user device 610 of FIG. 6. For example, the page engagement ranking module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the page engagement ranking module 102. The data maintained by the data store 120 can include, for example, information relating to pages, page engagement data, page-to-page engagement graphs, aggregated page-to-page engagement graphs, page rankings, types of engagement between pages, weights associated with types of engagement between pages, machine learning models, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the page engagement ranking module 102 can be configured to communicate and/or operate with the data store 120. In some embodiments, the data store 120 can be a data store within a client computing device. In some embodiments, the data store 120 can be a data store of a server system in communication with the client computing device.

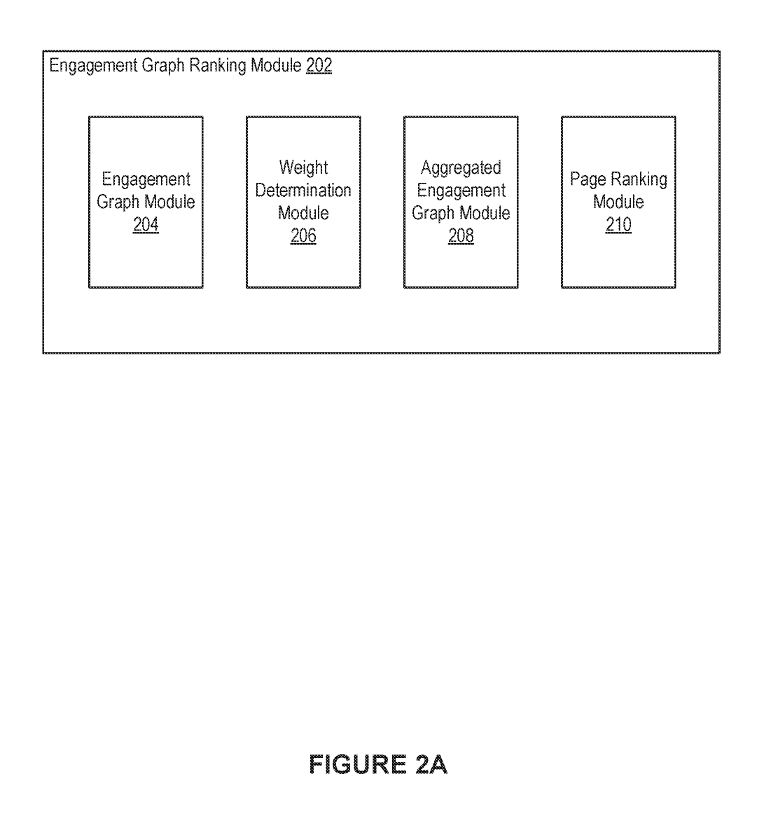

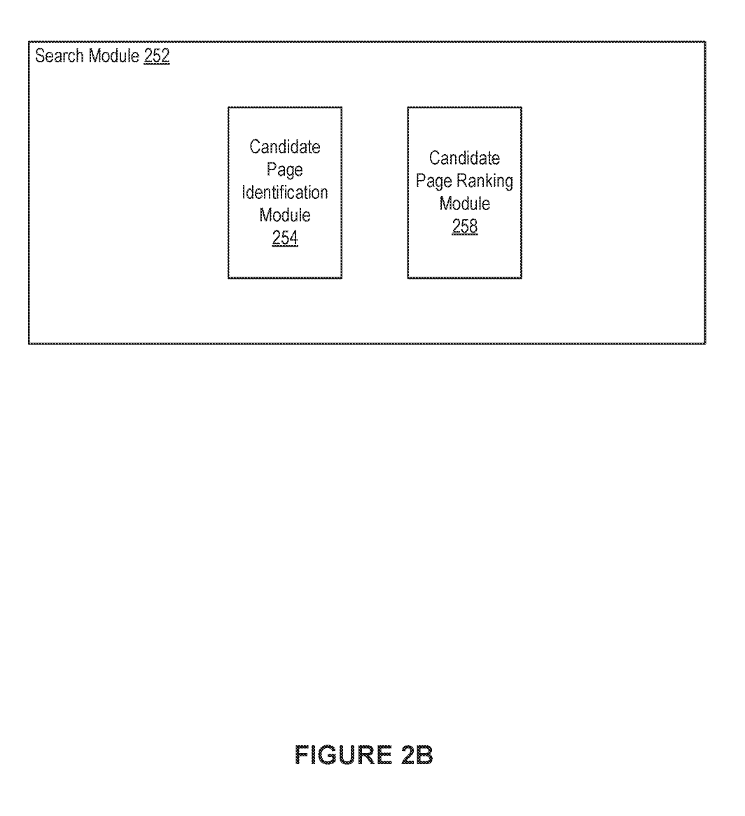

FIG. 2A illustrates an example engagement graph ranking module 202 configured to rank pages based on page-to-page engagement graphs, according to an embodiment of the present disclosure. In some embodiments, the engagement graph ranking module 104 of FIG. 1 can be implemented with the example engagement graph ranking module 202. As shown in the example of FIG. 2A, the example engagement graph ranking module 202 can include an engagement graph module 204, a weight determination module 206, an aggregated engagement graph module 208, and a page ranking module 210.

The engagement graph module 204 can generate one or more page-to-page engagement graphs based on different types of engagement between pages. A page-to-page engagement graph can also be herein referred to as a “page engagement graph.” A type of engagement can also be herein referred to as an “engagement type.” There can be different engagement types between pages. Examples of engagement types can include a page mentioning another page, a page becoming a fan of (e.g., fanning) another page, an administrator of a page becoming a fan of (e.g., fanning) another page, a page liking another page, a page liking posts of another page, etc. A page mentioning another page can include a reference by the page to the other page. For example, a page may mention another page in a post on the page. In some embodiments, a post can include any content provided in a social networking system. A page fanning another page can include the page becoming a fan of the other page, for example, by liking the page or subscribing to the page. In some embodiments, a page fanning another page can be the same as a page liking the other page. The engagement type of a page mentioning another page can be herein referred to as the “mention engagement type.” The engagement type of a page fanning another page can be herein referred to as the “fanning engagement type.” The engagement type of a page liking posts of another page can be herein referred to as the “like post engagement type.” Many variations are possible.

The engagement graph module 204 can generate a page engagement graph for each engagement type. For example, a page engagement graph can be generated for the mention engagement type, a page engagement graph can be generated for the fanning engagement type, and so forth. A page engagement graph for the mention engagement type can also be herein referred to as a “mention page engagement graph.” A page engagement graph for the fanning engagement type can also be herein referred to as a “fanning page engagement graph.” A page engagement graph can be a graph that represents engagement between pages. For example, a graph can be a structure that includes a set of entities or objects, in which some pairs of the entities or objects are related. A relationship between a pair of the entities or objects can be indicated by an edge in the graph. Likewise, a page engagement graph can indicate a connection or relationship between pages. For example, a connection or relationship between two pages in a page engagement graph can be represented by one or more edges between the two pages. The connection or relationship can be directed or undirected. There can be a value associated with an edge. In some embodiments, the value can be indicative of a strength of the connection or relationship between two pages. For instance, the value can be a weight or a coefficient associated with the connection or relationship. In certain embodiments, the value can be indicative of a count associated with the connection or relationship. For example, in connection with the mention page engagement graph, a page may mention another page multiple times, and a value associated with an edge between two pages can indicate a count of mentions of a page by another page.

In some embodiments, the engagement graph module 204 can represent a page engagement graph as a table including an entry with a first page and a second page associated with an edge and a value associated with the edge. If an edge between two pages is directed, the edge can be from the first page to the second page, or from the second page to the first page. If an edge between two pages is undirected, the edge can be between the first page and the second page without direction or sequence. As an example, a table for a mention page engagement graph can be as follows:

TABLE 1

| page 1 | page 2 | value |
|---|---|---|
| A | C | 1 |
| B | C | 2 |

where page 1 indicates a first page, page 2 indicates a second page, value indicates a value associated with an edge from the first page to the second page, and A, B, and C each indicates a page. The edge between the first page and the second page can be directed since the first page may mention the second page, but the second page may not mention the first page, or vice versa. In Table 1, an edge from A to C has a value of 1 associated with the edge, and an edge from B to C has a value of 2 associated with the edge. As another example, a table for a fanning page engagement graph can be as follows:

TABLE 2

| page 1 | page 2 | value |
|---|---|---|
| A | C | 1 |
| B | C | 1 |

where page 1 indicates a first page, page 2 indicates a second page, value indicates a value associated with an edge from the first page to the second page, and A, B, and C each indicates a page. The edge between the first page and the second page can be directed since the first page may fan the second page, but the second page may not fan the first page, or vice versa. In Table 2, an edge from A to C and an edge from B to C each has a value of 1 associated with the edge.

The weight determination module 206 can determine weights for different engagement types. In some embodiments, a weight for an engagement type can indicate relative importance of the engagement type compared to other engagement types. In certain embodiments, the weight for an engagement type can also indicate utility to a particular context or feature, such as a search. The weight for an engagement type can be applied to a value associated with an edge between two pages in a page engagement graph for the engagement type. As an example, the weight for a mention engagement type can be represented by a variable a, and the weight for a fanning engagement type can be represented by a variable b. In this example, an edge in the mention page engagement graph can be weighted by a, and an edge in the page engagement graph associated with the fanning type can be weighted by b. As an example, if a=2 and b=1, the mention engagement type can be considered to be twice as important as the fanning engagement type. In some embodiments, the weight determination module 206 can determine the weights for different engagement types based on machine learning techniques. For example, a machine learning model can be trained to predict a weight for each engagement type based on training examples. All examples herein are provided for illustrative purposes, and there can be many variations and other possibilities.

The aggregated engagement graph module 208 can generate an aggregated page engagement graph. For example, an aggregated page engagement graph can be generated based on page engagement graphs for different engagement types. The aggregated engagement graph module 208 can apply a weight associated with each page engagement graph to values associated with edges in the respective page engagement graph. The aggregated engagement graph module 208 can aggregate the weighted values from the respective page engagement graph in order to generate aggregated values associated with edges in an aggregated page engagement graph. For example, weighted values for an edge between the same two pages from page engagement graphs for different engagement types can be aggregated (e.g., summed, averaged, etc.) to generate an aggregated value for the edge. As an example, the mention page engagement graph and the fanning page engagement graph can be aggregated as follows. The weight a can be applied to values associated with edges in the mention page engagement graph, and the weight b can be applied to values associated with edges in the fanning page engagement graph. The weighted values from the mention page engagement graph and the weighted values from the fanning page engagement graph can be aggregated (e.g., summed, averaged, etc.). For example, an aggregated value for the edge from A to C can be determined as follows: (value from Table 1*a)+(value from Table 2*b)=(1*2)+(1*1)=3. As another example, an aggregated value for the edge from B to C can be determined as follows: (value from Table 1*a)+(value from Table 2*b)=(2*2)+(1*1)=5. An aggregated page engagement graph can include edges between pages in page engagement graphs for different engagement types and aggregated weighted values associated with the edges. In some embodiments, an aggregated page engagement graph can also be represented as a table. For example, a table for an aggregated page engagement graph can be as follows:

TABLE 3

| page 1 | page 2 | aggregated value |
|---|---|---|
| A | C | 3 |
| B | C | 5 |

where page 1 indicates a first page, page 2 indicates a second page, aggregated value indicates an aggregated value associated with an edge from the first page to the second page across multiple (e.g., two) engagement graphs, and A, B, and C each indicates a page.

The page ranking module 210 can rank pages based on an aggregated page engagement graph. The page ranking module 210 can apply a page ranking technique or algorithm to the aggregated page engagement graph. The page ranking algorithm can determine relative importance of pages in the aggregated page engagement graph. The page ranking algorithm can receive the aggregated page engagement graph as input and provide rankings or scores for pages in the aggregated page engagement graph as output. For example, the page ranking algorithm can determine a rank or score for each page based on edges between pages in the aggregated page engagement graph and values associated with the edges. The rank or score of a page can be determined recursively and based on a number of pages that have edges to the page and rankings or scores of the pages that have edges to the page. The rank or score for a page can indicate importance of the page. The page ranking algorithm be applied to any collection of elements or entities, such as a linked set of elements or entities. In certain embodiments, the page ranking technique or algorithm can be based on PageRank. For example, PageRank can refer to a link analysis algorithm that assigns a numerical weighting (“PageRank”) to each element of a hyperlinked set of documents, such as the World Wide Web. The PageRank can indicate importance of an element. The PageRank of a webpage can be defined recursively and can depend on the number and PageRanks of all webpages that link to the webpage (e.g., “incoming links”).

The page ranking module 210 can output a rank or score for each page in the aggregated page engagement graph. In some embodiments, the page ranking module 210 can determine rankings or scores for pages in the aggregated page engagement graph through a batch technique (e.g., offline). In other embodiments, the page ranking module 210 can determine rankings for pages in the aggregated page engagement graph in real time. In some embodiments, rankings or scores for pages can be represented as a table. For example, a table for rankings or scores for pages can be as follows:

TABLE 4

| page | score |
|---|---|
| A | s₁ |
| B | s₂ |
| C | s₃ |

where page indicates a page in an aggregated page engagement graph, score indicates a rank or score for a page in the aggregated page engagement graph, and A, B, and C each indicates a page. In Table 4, s₁, s₂, and s₃ each can represent a numerical value. The rankings or scores for pages can be stored, for example, in a data store, such as the data store 120.

In some embodiments, as described above, a weight for a page engagement graph for a particular engagement type can be applied to values associated with edges in the page engagement graph prior to generating an aggregated page engagement graph based on page engagement graphs for different engagement types. In other embodiments, the page ranking module 210 can apply the page ranking algorithm to each page engagement graph of various page engagement graphs for different engagement types, instead of generating an aggregated page engagement graph. For example, the page ranking algorithm can be applied to a page engagement graph for a particular engagement type in order to determine rankings or scores for pages in the page engagement graph. The weight for the page engagement graph can then be applied to rankings or scores for pages in the page engagement graph. Weighted rankings or scores for each of page engagement graphs for different engagement types can then be aggregated to generate aggregated rankings or scores for pages. All examples herein are provided for illustrative purposes, and there can be many variations and other possibilities.

FIG. 2B illustrates an example search module 252 configured to provide pages in response to a search of data maintained by a social networking system, according to an embodiment of the present disclosure. In some embodiments, the search module 106 of FIG. 1 can be implemented with the example search module 252. As shown in the example of FIG. 2B, the example search module 252 can include a candidate page identification module 254 and a candidate page ranking module 256. The search module 252 can receive search queries and provide search results including one or more pages.

The candidate page identification module 254 can identify one or more candidate pages that are candidates for inclusion in search results determined in response to a search query. For example, a search query can be received from a computing device of a user or member of a social networking system. A search query can include various search criteria. In some embodiments, the search criteria can be based on page attributes. Page attributes can include any attributes associated with pages. Examples of page attributes can include a name of a page, an entity associated with a page, a page category, a location (e.g., a country, state, county, city, etc.), operating hours, a number of connections of a page, popularity of a page, whether a page is claimed by an entity represented by a page (e.g., owned or unowned), etc. Many variations are possible. The candidate page identification module 254 can identify one or more pages in response to the search criteria.

The candidate page ranking module 256 can rank candidate pages identified in response to a search query based on respective rankings or scores of the candidate pages. The candidate page ranking module 256 can obtain determined rankings or scores of the candidate pages and rank the candidate pages in the order of the rankings or scores. For example, the rankings or scores of the candidate pages can be determined by the engagement graph ranking module 202, as described above. The rankings or scores of the candidate pages may be obtained from a data store, such as the data store 120. The ranked candidate pages can be provided for display in a user interface on a computing device associated with the search query. In some embodiments, only ranked candidate pages that satisfy a threshold value are provided for display. All examples herein are provided for illustrative purposes, and there can be many variations and other possibilities.

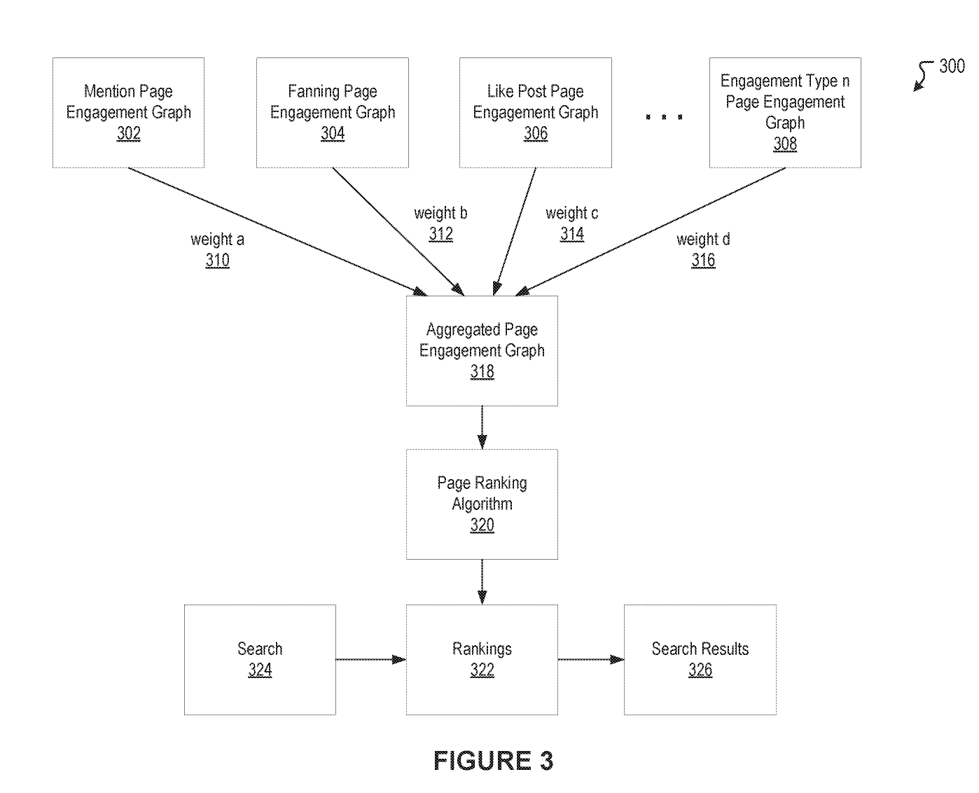

FIG. 3 illustrates an example functional block diagram 300 for ranking pages based on page-to-page engagement, according to an embodiment of the present disclosure. As discussed, there can be many different engagement types, and each engagement type can have an associated page engagement graph. FIG. 3 includes a mention page engagement graph 302, a fanning page engagement graph 304, a like post page engagement graph 306, and an engagement type n page engagement graph 308. A like post page engagement graph 306 can refer to a page engagement graph for a like post engagement type. An engagement type n page engagement graph 308 can refer to a page engagement graph for an engagement type n. A page engagement graph for a particular engagement type can have an associated weight. In the example of FIG. 3, weight a 310 is associated with the mention page engagement graph 302; weight b 312 is associated with the fanning page engagement graph 304; weight c 314 is associated with the like post page engagement graph 306; and weight d 316 is associated with the engagement type n page engagement graph 308. The weight for a page engagement graph for a particular engagement type can be applied to values associated with edges between pages in the page engagement graph. For example, weight a 310 can be applied to values associated with edges in the mention page engagement graph 302, weight b 312 can be applied to values associated with edges in the fanning page engagement graph 304, and so forth. Edges from page engagement graphs for different engagement types and weighted values associated with the edges can be aggregated in order to generate an aggregated page engagement graph 318. The aggregated page engagement graph 318 can be provided as input to a page ranking algorithm 320, and the page ranking algorithm 320 can output rankings or scores 322 for pages in the aggregated page engagement graph 318. The rankings or scores 322 can be used to rank candidate pages for a search. In this regard, a search 324 involving a query against data maintained by a social networking system can be received. The search 324 can be requested by a user or a member of the social networking system. Based on the rankings 322, certain pages can be determined in response to the query. These pages, or a threshold portion of these pages, can constitute search results 326 that are provided for display to the user or member. All examples herein are provided for illustrative purposes, and there can be many variations and other possibilities.

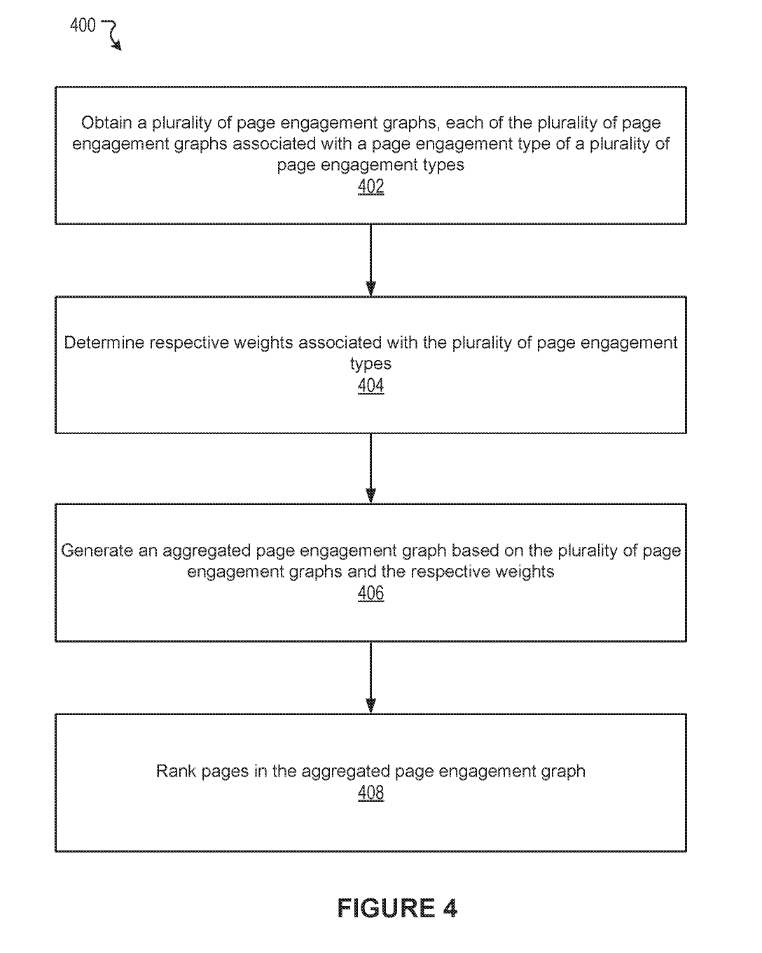

FIG. 4 illustrates an example first method 400 for ranking pages based on page-to-page engagement, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a plurality of page engagement graphs, each of the plurality of page engagement graphs associated with a page engagement type of a plurality of page engagement types. At block 404, the example method 400 can determine respective weights associated with the plurality of page engagement types. At block 406, the example method 400 can generate an aggregated page engagement graph based on the plurality of page engagement graphs and the respective weights. At block 408, the example method 400 can rank pages in the aggregated page engagement graph. Other suitable techniques that incorporate various features and embodiments of the present disclosure are possible.

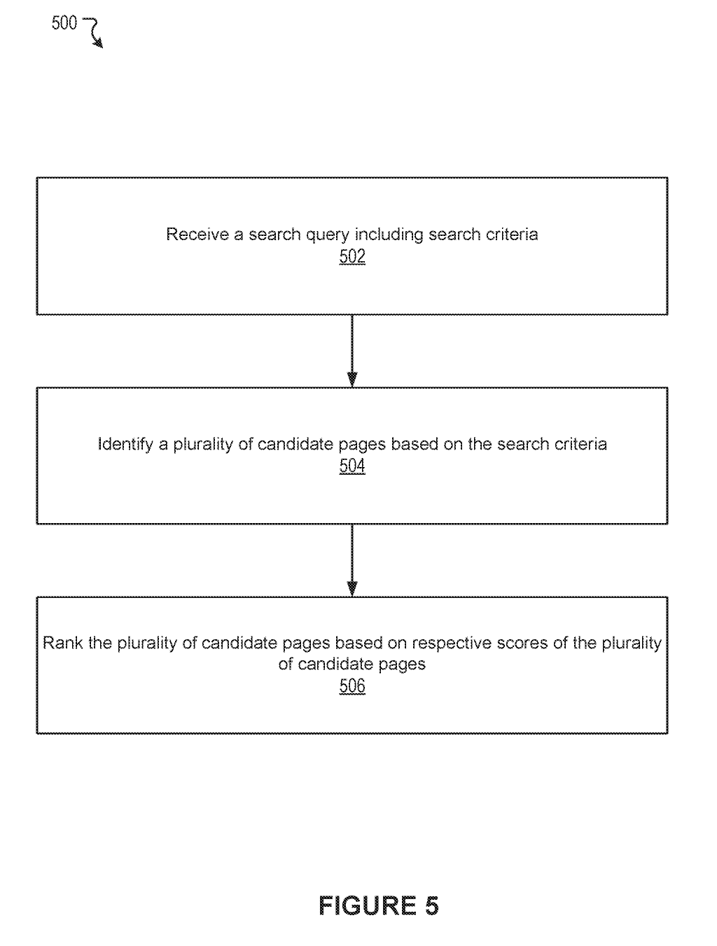

FIG. 5 illustrates an example second method 500 for ranking pages based on page-to-page engagement, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can receive a search query including search criteria. At block 504, the example method 500 can identify a plurality of candidate pages based on the search criteria. At block 506, the example method 500 can rank the plurality of candidate pages based on respective scores of the plurality of candidate pages. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a page engagement ranking module 646. The page engagement ranking module 646 can be implemented with the page engagement ranking module 102, as discussed in more detail herein. In some embodiments, one or more functionalities of the page engagement ranking module 646 can be implemented in the user device 610.

### Hardware Implementation

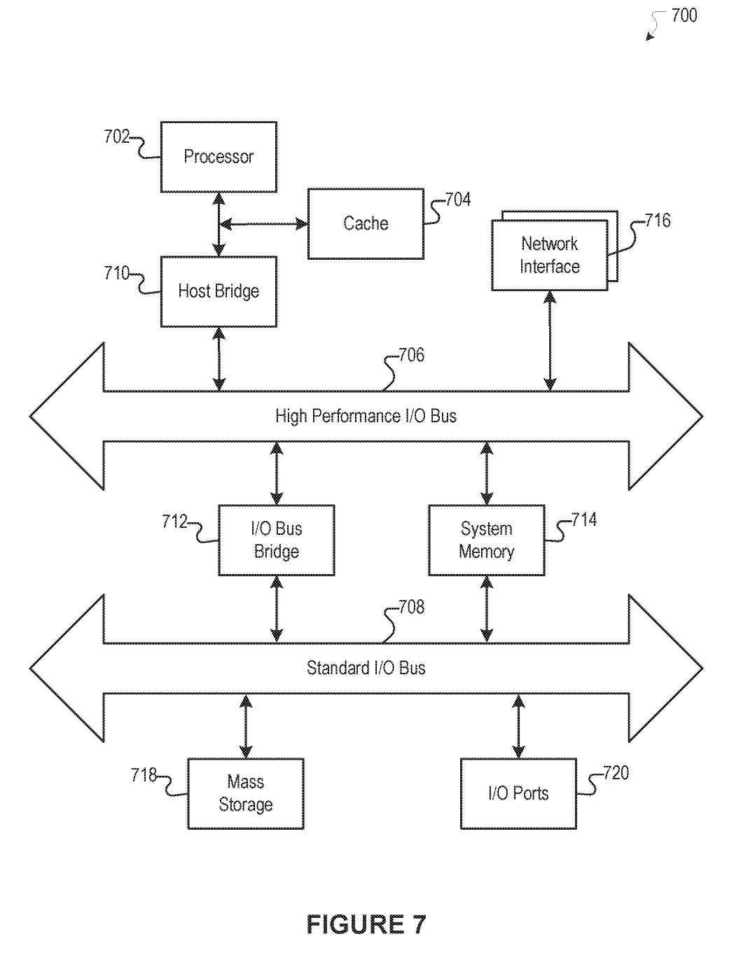

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718.

However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a plurality of page engagement graphs, each of the plurality of page engagement graphs associated with a page engagement type of a plurality of page engagement types;
determining, by the computing system, respective weights associated with the plurality of page engagement types;
generating, by the computing system, an aggregated page engagement graph based on the plurality of page engagement graphs and the respective weights; and
ranking, by the computing system, pages in the aggregated page engagement graph.

2. The computer-implemented method of claim 1, wherein each of the plurality of page engagement graphs includes edges between pages associated with a social networking system and respective values associated with the edges.

3. The computer-implemented method of claim 2, wherein a value associated with an edge between two pages is indicative of a strength of a connection or relationship between the two pages.

4. The computer-implemented method of claim 2, wherein the generating the aggregated page engagement graph comprises:
applying the respective weights to the values associated with the edges of the plurality of page engagement graphs to generate weighted values associated with the edges of the plurality of the page engagement graphs;
aggregating the weighted values associated with the edges of the plurality of the page engagement graphs; and
generating the aggregated page engagement graph that includes the edges of the plurality of the page engagement graphs and the aggregated weighted values.

5. The computer-implemented method of claim 4, wherein the ranking the pages in the aggregated page engagement graph comprises generating a score for each page in the aggregated page engagement graph, the score indicative of importance of the page.

6. The computer-implemented method of claim 5, wherein the score for each page is determined based on edges from other pages to the page in the aggregated page engagement graph and respective scores of the other pages.

7. The computer-implemented method of claim 6, wherein the score for each page is determined recursively.

8. The computer-implemented method of claim 5, further comprising:
receiving a search query including search criteria;
identifying a plurality of candidate pages based on the search criteria; and
ranking the plurality of candidate pages based on respective scores of the plurality of candidate pages.

9. The computer-implemented method of claim 1, wherein the determining the respective weights associated with the plurality of engagement types is based on a machine learning model.

10. The computer-implemented method of claim 1, wherein the plurality of engagement types includes one or more of: a page mentioning another page, a page becoming a fan of another page, or a page liking posts of another page.

11. A system comprising:
at least one hardware processor; and
a memory storing instructions that, when executed by the at least one processor, cause the system to perform:
obtaining a plurality of page engagement graphs, each of the plurality of page engagement graphs associated with a page engagement type of a plurality of page engagement types;
determining respective weights associated with the plurality of page engagement types;
generating an aggregated page engagement graph based on the plurality of page engagement graphs and the respective weights; and
ranking pages in the aggregated page engagement graph.

12. The system of claim 11, wherein each of the plurality of page engagement graphs includes edges between pages associated with a social networking system and respective values associated with the edges.

13. The system of claim 12, wherein the generating the aggregated page engagement graph comprises:
applying the respective weights to the values associated with the edges of the plurality of page engagement graphs to generate weighted values associated with the edges of the plurality of the page engagement graphs;
aggregating the weighted values associated with the edges of the plurality of the page engagement graphs; and
generating the aggregated page engagement graph that includes the edges of the plurality of the page engagement graphs and the aggregated weighted values.

14. The system of claim 13, wherein the ranking the pages in the aggregated page engagement graph comprises generating a score for each page in the aggregated page engagement graph, the score indicative of importance of the page.

15. The system of claim 14, wherein the instructions further cause the system to perform:
receiving a search query including search criteria;
identifying a plurality of candidate pages based on the search criteria; and
ranking the plurality of candidate pages based on respective scores of the plurality of candidate pages.

16. A non-transitory computer readable medium including instructions that, when executed by at least one hardware processor of a computing system, cause the computing system to perform a method comprising:
obtaining a plurality of page engagement graphs, each of the plurality of page engagement graphs associated with a page engagement type of a plurality of page engagement types;
determining respective weights associated with the plurality of page engagement types;
generating an aggregated page engagement graph based on the plurality of page engagement graphs and the respective weights; and
ranking pages in the aggregated page engagement graph.

17. The non-transitory computer readable medium of claim 16, wherein each of the plurality of page engagement graphs includes edges between pages associated with a social networking system and respective values associated with the edges.

18. The non-transitory computer readable medium of claim 17, wherein the generating the aggregated page engagement graph comprises:
applying the respective weights to the values associated with the edges of the plurality of page engagement graphs to generate weighted values associated with the edges of the plurality of the page engagement graphs;
aggregating the weighted values associated with the edges of the plurality of the page engagement graphs; and
generating the aggregated page engagement graph that includes the edges of the plurality of the page engagement graphs and the aggregated weighted values.

19. The non-transitory computer readable medium of claim 18, wherein the ranking the pages in the aggregated page engagement graph comprises generating a score for each page in the aggregated page engagement graph, the score indicative of importance of the page.

20. The non-transitory computer readable medium of claim 19, wherein the method further comprises:
receiving a search query including search criteria;
identifying a plurality of candidate pages based on the search criteria; and
ranking the plurality of candidate pages based on respective scores of the plurality of candidate pages.
